(19) United States
(12) Patent Application Publication
(10) Pub. No.: US 2019/0106329 A1
(43) Pub. Date: Apr. 11, 2019

(54) SPHERICAL EUCRYPTITE PARTICLES AND METHOD FOR PRODUCING SAME

(71) Applicant: NIPPON STEEL & SUMIKIN MATERIALS CO., LTD., Tokyo (JP)

(72) Inventors: Yutaka SATO, Tokyo (JP); Katsumasa YAGI, Tokyo (JP); Mutsuhito TANAKA, Tokyo (JP); Masanori AE, Tokyo (JP); Shozo TOKUDA, Tokyo (JP); Tadashi MATSUMOTO, Tokyo (JP)

(73) Assignee: NIPPON STEEL & SUMIKIN MATERIALS CO., LTD., Tokyo (JP)

(21) Appl. No.: 16/089,244

(22) PCT Filed: Mar. 21, 2017
(86) PCT No.: PCT/JP2017/011257

§ 371 Date: Sep. 27, 2018

(30) Foreign Application Priority Data
Mar. 28, 2016 (JP) 2016-064052

(51) Int. Cl. C01B 33/32; C08K 3/34; C08K 7/18; C03B 19/06

(52) U.S. Cl. CPC C01B 33/32; C08K 3/34; C08K 7/18; C03B 19/06; C08K 2201/005; C01P 2006/32; C01P 2004/61; C08K 2003/343; C01P 2004/32

(57) ABSTRACT

The present invention addresses the problem of providing: spherical eucryptite particles which have higher circularity than in the prior art, have a large negative thermal expansion and a high thermal conductivity, have high flowability, dispersibility, and filling capability, and are also applicable in the field of semiconductors; and a method for producing the spherical eucryptite particles. As a means for solving the problem, the present invention provides: the method for producing the spherical eucryptite particles characterized by heat treating, at 600 to 1100° C., spherical particles which have been thermally sprayed with a feedstock powder that includes 45 to 55 mol % of SiO₂, 20 to 30 mol % of Al₂O₃, and 20 to 30 mol % of Li₂O, and obtaining spherical particles that include 89% or more of a eucryptite crystalline phase; and the spherical eucryptite particles obtained by this method.

### FIELD

The present invention relates to spherical eucryptite particles and a method for producing the same.

### BACKGROUND

Particles of an inorganic material are used as a resin filler, for example, silica (SiO₂) is used as a filler for a sealing material of a semiconductor element. Regarding a shape of silica particles, if it is in an angular shape, the flowability, dispersibility and filling property in the resin deteriorates, and abrasion to a manufacturing apparatus also proceeds. In order to improve these properties, spherical silica particles are widely used.

Generally, spherical silica is produced by thermal spraying method. In thermal spraying, by passing particles as feedstock through a flame, the particles melt and the shape of the particles becomes spherical due to surface tension. The molten and spheroidized particles are collected by air flow transportation so that they do not fuse together, but the particles after thermal spraying are quenched. Since the particles are quenched from the molten state, silica of the particles contains almost no crystals and has an amorphous structure.

Since the spherical silica is amorphous, its thermal expansion coefficient and thermal conductivity are low. The thermal expansion coefficient of the amorphous silica is 0.5 ppm/K, and the thermal conductivity is 1.4 W/mK. These physical properties are roughly equivalent to quartz glass which has an amorphous structure without a crystal structure and has a comparable thermal expansion coefficient.

An effect of reducing thermal expansion coefficient of a resin can be obtained by mixing amorphous silica having a low thermal expansion coefficient with the resin. Especially in semiconductor sealing materials, by mixing a filler of amorphous silica with a resin, a thermal expansion coefficient of the sealing materials can be brought close to the thermal expansion coefficient of a semiconductor chip, and thus warp and crack due to heating/cooling at reflow and elevation of an operating temperature of a semiconductor device can be suppressed.

However, with the high integration of semiconductor chips and the like, it is necessary to further reduce the thermal expansion of the filler-resin mixture.

Since the amorphous silica has a thermal expansion coefficient of nearly zero, it is necessary to use a material having a negative thermal expansion coefficient in order to further lower the thermal expansion of the resin mixture. As a material having a negative thermal expansion coefficient, eucryptite (LiAlSiO₄) which is a complex oxide of Li, Al and Si is known.

Eucryptite is a special material with different thermal expansion coefficients for each crystal axis (a-axis=8.21×10⁻⁶/K, b-axis=−17.6×10⁻⁶/K). In order to have a negative expansion coefficient, it is necessary that it is composed of crystals.

Patent Document 1 discloses an inorganic powder having one or more crystalline phases selected from β-eucryptite, β-eucryptite solid solution, β-quartz, β-quartz solid solution, wherein it has a negative thermal expansion coefficient in the range of a temperature of −40° C. to +600° C. and has d90 of 150 μm or less, and d50 of 1 μm or more and 50 μm or less in the particle size distribution (median diameter).

In Patent Document 2 proposes a filler powder having a thermal expansion coefficient in a range of 30 to 150° C. of 5×10⁻⁷/° C. or less, as a filler powder made of a crystallized glass obtained by precipitating β-quartz solid solution and/or β-eucryptite solid solution.

### PRIOR ART DOCUMENT

### Patent Document

Patent Document 1: Japanese Unexamined Patent Publication (kokai) No. 2007-91577
Patent Document 2: Japanese Unexamined Patent Publication (kokai) No. 2015-127288

### SUMMARY

### Problems to be Solved by the Invention

There is a demand for using semiconductor products in various environments. Especially when used in a high temperature environment, it is required that there is no warpage or cracks. In that case, a filler having a negative thermal expansion coefficient and a high thermal conductivity is useful. Furthermore, in order to exert such properties of the filler in the resin mixture, it is necessary that the filler has a spherical shape capable of having a high fluidity, a high dispersibility and being highly filled.

In addition, when used as a resin filler for a semiconductor sealing material, warpage and cracks, etc. occurs during performing a high temperature process such as a sealing process or a reflow process due to a difference between the thermal expansion coefficient of a semiconductor, a substrate, or the like and the thermal expansion coefficient of the sealing material. SiO₂ having a low thermal expansion coefficient is used as a filler for the sealing material. However, in order to obtain a sealing material having a thermal expansion coefficient close to that of a semiconductor, a substrate, or the like, a filler having a lower thermal expansion coefficient, or even having a negative expansion coefficient is required.

As a method for obtaining a negative expansion filler, there is a method of preparing a negative thermal expansion glass ceramic and pulverizing the glass ceramic by a pulverizing apparatus such as a ball mill (Patent Document 1). However, since the filler obtained by pulverization is angular, it has a low flowability and dispersibility, and thus there is a problem that it cannot be mixed with the resin at a high filling ratio.

Another method is proposed as follows: in order to obtain a filler powder made of a crystallized glass obtained by precipitating β-quartz solid solution and/or β-eucryptite, a feedstock batch obtained by mixing glass feedstocks at a predetermined ratio is melted to obtain a molten glass, then forming the molten glass into a predetermined shape (for example, a plate shape) to obtain a bulk crystalline glass, and furthermore the bulk crystalline glass is subjected to a heat treatment at a predetermined condition, thereby precipitating β-quartz solid solution and/or β-eucryptite therein to obtain a bulk crystallized glass, and subjecting the obtained bulk crystallized glass to a predetermined pulverization treatment (Patent Document 2).

In this case as well, as in Patent Document 1, since particles obtained by pulverization are angular, fluidity and dispersibility are low and it is difficult to mix with resin at a high filling ratio. Therefore, Patent Document 2 discloses that, after bulk crystalline glass obtained by molding molten glass is pulverized to prepare a crystalline glass powder, heat treatment may be subjected to the crystalline glass powder to crystallize it. By thermally spraying the crystalline glass powder into flame for heat treatment before crystallizing it, the surface of the crystalline glass powder is softened and fluidized to obtain a substantially spherical filler powder. It is also said that it becomes possible to obtain a substantially columnar filler powder by spinning molten glass to fiberize it, then pulverizing it and performing heat treatment.

However, a substantially spherical filler powder obtained by softening and flowing only the surface of the pulverized powder by heat treatment or a substantially columnar filler powder obtained by pulverizing the fiberized glass and its heat treatment has a lower circularity than (that of) spherical particles which are obtained by melting the entire particles like spherical silica particles. Therefore, the flowability and dispersibility are low, and there is a problem that the filling ratio when mixed with a resin cannot be as high as that of spherical silica particles.

Furthermore, in these methods, although it is necessary to form homogeneous glass once, it is not possible to uniformly melt the glass in the case of a material having a large negative expansion such as eucryptite. Therefore, it is necessary to make the material have a composition with more SiO₂ than eucryptite to add components other than Li, Al and Si to melt the whole. For this reason, it is difficult to obtain a desired large negative thermal expansion coefficient.

In addition, since crystallization is performed by heat treatment after the whole material is vitrified, it becomes difficult to completely crystallize the material and an amorphous component remains therein. Therefore, there is a problem that it is difficult to obtain a desired large negative thermal expansion coefficient.

The object of the present invention is to provide spherical eucryptite particles and a method for producing the same, wherein the eucryptite particles have a high degree of circularity and a large negative thermal expansion coefficient and high thermal conductivity as compared with the prior art and has a high fluidity, a high dispersibility and a high filling property, and is suitable for a semiconductor field.

### Means for Solving the Problems

According to the present invention, the following aspects are provided.

[1]

Spherical eucryptite particles comprising a eucryptite crystalline phase containing 45 to 55 mol % of SiO₂, 20 to 30 mol % of Al₂O₃ and 20 to 30 mol % of Li₂O, and having a circularity of 0.90 to 1.0.

[2]

The spherical eucryptite particles according to item 1, characterized in that their thermal expansion coefficient is −2×10⁻⁶/K to −10×10⁻⁶/K.

[3]

The spherical eucryptite particles according to item 1 or 2, wherein the average particle diameter (D50) is more than 1 μm to 100 μm.

[4]

A method for producing spherical eucryptite particles according to any one of items 1 to 3 characterized in that spherical particles obtained by thermally spraying a feedstock powder containing 45 to 55 mol % of SiO₂, 20 to 30 mol % of Al₂O₃ and 20 to 30 mol % of Li₂O, are heat treated to obtain spherical particles containing 89% or more of a eucryptite crystalline phase.

[5]

The method for producing spherical eucryptite particles according to item 4, characterized in that the thermally sprayed spherical particles are heat treated at 500 to 1000° C. for 1 to 48 hours.

### Effect of the Invention

According to the present invention, it is possible to provide spherical eucryptite particles which have a higher degree of circularity than the conventional one, have a large negative thermal expansion coefficient and a high thermal conductivity, and have a high fluidity, a high dispersibility and high filling property, and also applicable in the field of semiconductors. Further, according to the present invention, a method for producing said spherical eucryptite particles having higher productivity and lower manufacturing cost than conventional methods is provided.

### Embodiments for Carrying Out the Invention

As a result of diligent studies in order to solve the above-mentioned problems, the inventors have found that, by heat treating spherical particles obtained by thermally spraying a feedstock powder containing 45 to 55 mol % of SiO₂, 20 to 30 mol % of Al₂O₃ and 20 to 30 mol % of Li₂O, almost completely crystallized particles are obtained and their crystalline phase is a eucryptite crystalline phase and their circularity is equivalent to that of the thermally sprayed particles, and spherical eucryptite particles having an extremely high circularity, as high as 0.90 to 1.0 can be achieved.

The spherical eucryptite particles of the present invention comprise from 45 to 55 mol % of SiO₂, from 20 to 30 mol % of Al₂O₃ and from 20 to 30 mol % of Li₂O. By comprising SiO₂, Al₂O₃ and Li₂O at this ratio, it is possible to obtain particles in which the resulting particles are almost completely composed of eucryptite crystals. When the ratio of SiO₂, Al₂O₃ and Li₂O deviates from this ratio, a crystalline phase other than eucryptite is formed or an amorphous phase is included. As a result, the thermal expansion coefficient of the particles becomes large and the intended negative thermal expansion particles cannot be obtained.

The ratio of Si, Li and Al can be measured by, for example, atomic absorption spectrometry, ICP mass spectrometry (ICP-MS). Preferably, an atomic absorption method is used. By converting the metal component obtained by these analysis methods into an oxide basis, the proportion of SiO₂, Al₂O₃ and Li₂O can be calculated.

In the spherical eucryptite particles of the present invention, it is desirable that the crystalline phase constitutes 99% or more of the whole particles. When the proportion of the crystalline phase is less than 99%, an amorphous material having a thermal expansion larger than that of the eucryptite crystal is contained, and thus the thermal expansion coefficient of the particles becomes large.

The proportion of the crystalline phase can be measured, for example, by X-ray diffraction (XRD). When measured by XRD, it can be calculated from the sum of integral intensities of crystalline peaks (Iu) and integral intensities of amorphous halo portions (Ia) by the following formula.

X (crystalline phase proportion)=Iu/(Iu+Ia)×100 (%)

In the spherical eucryptite particles of the present invention, it is desirable that 90% or more of the crystalline phases are composed of eucryptite crystalline phases. When the proportion of eucryptite crystals in the crystalline phase is less than 90%, the crystalline phase having a thermal expansion larger than the eucryptite crystal is contained, and thus the thermal expansion coefficient of the particles becomes large.

In addition, in order to obtain a larger negative expansion effect, it is desirable that the proportion of eucryptite crystals in the crystalline phase is 99% or more.

The proportion of eucryptite crystalline phase can be measured, for example, by X-ray diffraction (XRD). When measured by XRD, it can be calculated from the sum of the integral intensities of the peaks of the eucryptite crystalline phase (Iu′) and the sum of the integral intensities of the peaks of other crystalline phases (Ic) by the following formula. X′(eucryptite crystalline phase proportion)=Iu′/(Iu′+Ic)×100 (%)

For the eucryptite crystalline phase, Ic can be calculated from the sum of integral intensities of respective peaks, for example, using the peak data of PDF 00-014-0667. Also, in the eucryptite crystal, the diffraction peak of the crystal may differ depending on the component ratio, and there are multiple pdf data. It is desirable to use eucryptite pdf data that most closely matches the detected peak. In addition, crystalline phase of pseudo-eucryptite (Pseudo Eucryptite, PDF 01-070-1580) which is a similar crystal can achieve the same effect as eucryptite.

As described above, it is desirable that 99% or more of the whole spherical eucryptite particles of the present invention are composed of crystalline phases, and 90% or more of the crystalline phases thereof are composed of eucryptite crystalline phases. Therefore, it is desirable that the spherical eucryptite particles of the present invention are composed of a eucryptite crystalline phase of 89% or more (0.99×0.90≈0.89). The remainder may include a pseudo-eucryptite crystalline phase.

The spherical eucryptite particles of the present invention have a circularity of 0.90 or more. The circularity in the present invention is conveniently and preferably measured by a commercially available flow type particle image analyzer. In addition, relatively large particles can be measured from a microscopic photograph of an optical microscope and relatively small particles can be measured from a microscopic photograph of a scanning electron microscope (SEM), etc. using image analysis processing software as follows. Take a picture of a sample of at least 100 particles and measure an area and a perimeter of each particle (2D projection). Assuming that the particle is a perfect circle, calculate a circumference of the perfect circle having the measured area. Circularity is obtained by the formula of circularity=circumference/perimeter length. When circularity=1, it is a perfect circle. In other words, the closer circularity is to 1, the closer it is to a perfect circle. The average of circularity of each particle thus obtained is calculated to obtain the circularity of the particles of the present invention. If the circularity is less than 0.90, the fluidity, dispersibility and filling property when mixing with a resin are not sufficient, and abrasion of the apparatus for mixing the particles and the resin may be promoted in some cases.

The spherical eucryptite particles of the present invention may have a thermal expansion coefficient of −2×10⁻⁶/K to −10×10⁻⁶/K. Since it is difficult to measure a thermal expansion coefficient of particles alone, a thermal expansion coefficient in the present invention is measured by measuring a thermal expansion coefficient of a resin composition prepared by mixing the spherical eucryptite particles with a resin. It is preferable to calculate a thermal expansion coefficient of the spherical eucryptite particles from the filling ratio of the spherical eucryptite particles and the thermal expansion coefficient of the resin. In this case, the calculation is made assuming that the thermal expansion coefficient of the resin mixture complies with a compound law of the thermal expansion coefficients of the spherical eucryptite particles and of the resin.

The spherical eucryptite particles of the present invention may have an average particle diameter (D50) of more than 1 μm to 100 μm. If the average particle diameter exceeds 100 μm, when the particles are used as a filler for a semiconductor sealing material or the like, their particle diameter is too coarse and it is likely to cause a gate clogging or mold wear. In addition, since the particle diameter is large, the entire particles are hardly crystallized. Therefore, it is preferably 50 μm or less. Also, if the average particle diameter is 1 μm or less, the particles are too fine, that is, the surface area ratio of the particles becomes too large, and the particles tend to bond together by fusion or sintering, and it may become impossible to fill a large amount of the particles.

More desirably, particles having an average particle diameter of 3 μm or more are used. In the case of crystallization by heat treatment, the higher temperature promotes the higher degree of crystallization, and crystalline spherical particles with good characteristics can be obtained. However, at such a high temperature, particles having an average particle diameter of less than 3 μm are likely to agglomerate, and the circularity may become low. By using particles having a particle diameter of 3 μm or more, it is possible to crystallize the particles without causing agglomeration even at a temperature at which the degree of crystallization sufficiently progresses.

Incidentally, the average particle diameter herein is the particle diameter measured by particle size distribution measurement by the laser diffraction method. The particle size distribution by the laser diffraction method can be measured with Master Sizer 3000 manufactured by Malvern, for example.

The average size diameter referred herein is called as median diameter. The particle diameter distribution is measured by a method such as laser diffraction method, and the particle diameter at which the cumulative frequency of the particle diameter becomes 50% is defined as the average particle diameter (D50).

The method for production of the present invention will be described. The spherical eucryptite particles of the present invention can be produced by a method including the following steps, that is, the production method of the present invention, comprising

(i) preparing a feedstock powder containing 45 to 55 mol % of SiO₂, 20 to 30 mol % of Al₂O₃ and 20 to 30 mol % of Li₂O;

(ii) thermally spraying the prepared feedstock powder;

(iii) heat-treating (retaining) the thermally sprayed spherical particles at 500 to 1000° C. for 1 to 48 hours;

(iv) cooling the heat treated (retained) spherical particles.

The spherical eucryptite particles produced by this method have 99% or more of a crystalline phase, and 90% or more of the crystalline phase is composed of an eucryptite crystalline phase, and therefore 89% or more (0. 99×0.900.89) of the spherical eucryptite particles is composed of a eucryptite crystalline phase. The remainder of the spherical eucryptite particles may comprise a pseudo-eucryptite crystalline phase.

It is desirable to use a feedstock powder containing 45 to 55 mol % of SiO₂, 20 to 30 mol % of Al₂O₃ and 20 to 30 mol % of Li₂O as a feedstock before thermal spraying.

As feedstocks before thermal spraying, respective powders of SiO₂, Al₂O₃ and Li₂O can be mixed and used. In addition, SiO₂, Al₂O₃ and Li₂O can be used by mixing complex oxides containing any of the components so as to have a target composition. In addition, carbonate, nitrate, hydroxide, chloride and the like can also be used.

Although a feedstock having the above composition is used as the feedstock before thermal spraying, it is desirable to use a material before thermal spaying which has been obtained by mixing, melting or reacting the components at a high temperature to form uniformly contained components. If the components are not uniform, crystals other than eucryptite are generated when heat treatment of the thermally sprayed particles is performed, and desired negative expansion particles may not be obtained.

In addition, it is more preferable to use a powder containing a eucryptite crystalline phase as the feedstock before thermal spraying. By using a powder containing a eucryptite crystalline phase as the feedstock before thermal spraying, eucryptite crystals are likely to precipitate in the particles after thermal spraying, which becomes crystal nuclei, and the subsequent heat treatment allows the entire particles to form eucryptite crystal even at a low temperature.

Furthermore, by using eucryptite particles as the feedstock before thermal spraying, spherical eucryptite particles can be obtained by thermal spraying and heat treatment while keeping the eucryptite composition. For this reason, it is preferable to use, as the feedstock before thermal spraying, eucryptite which has been obtained by mixing feedstocks containing SiO₂, Al₂O₃, Li₂O or these components and melting or reacting them at a high temperature

In the case of preparing the spherical eucryptite particles of the present invention by thermal spraying, it is possible to control the particle diameter of the spherical particles after thermal spraying within the target range by adjusting the particle diameter of the feedstock before thermal spraying. When spherical particles are prepared by thermal spraying, spherical particles having substantially the same particle diameter as the feedstock can be obtained unless agglomeration of the feedstock particles or adhesion of the particles during thermal spraying occurs. In addition, the average particle diameter of the spherical eucryptite particles of the present invention hardly changes before and after the heat treatment for crystallizing the entire particles into the eucryptite crystalline phase.

In order to increase the circularity after the heat treatment, it is necessary to increase the circularity of the spherical particles after thermal spraying. The spherical particles obtained by thermal spraying may have a circularity of 0.90 or more. Individual particles of the feedstock powder are melted at the stage of thermal spraying, whereby particles with a high circularity can be easily obtained. When the powder particles of the feedstock do not melt during thermal spraying, spheroidization due to the surface tension of the melt does not occur sufficiently, resulting in non-spherical particles leaving an angular shape of the feedstock powder before thermal spraying. Therefore, in thermal spraying of the feedstock powder, it is desirable to thermally spray the feedstock powder into the flame of 1600° C. or higher at which the feedstock is melted.

In addition, since the circularity of the spherical eucryptite particles of the present invention hardly decreases before and after the heat treatment (retaining) after thermal spraying, it is important to keep the circularity of the spherical particles high after thermal spraying.

Spherical particles obtained by thermal spraying may have an average particle diameter (D50) of more than 1 μm to 100 μm. By using thermal spraying, a particle diameter can be easily adjusted by using feedstock particle diameter having the intended final product particle diameter. Also, in the heat treatment, the particle diameter of the spherical particles hardly changes. Therefore, according to the method of the present invention, spherical eucryptite particles having a desired average particle diameter can be easily realized.

Spherical particles obtained by thermal spraying are composed of an amorphous phase and/or a crystalline phase. Most of the feedstock powder melts during thermal spraying and solidifies in the subsequent cooling process. In general thermal spraying, since the particles after thermal spraying are quenched in a short time, they will include an amorphous phase. However, when the feedstock of the composition of the present invention is thermally sprayed, the eucryptite crystalline phase precipitates during the cooling process, and it becomes a crystal nucleus at the subsequent heat treatment, and thus it is easy to generate eucryptite crystals.

The spherical eucryptite particles of the present invention can be obtained by heat treating spherical particles after thermal spraying, the heat treating being at 500 to 1000° C. Heat treatment in this temperature range makes it possible to obtain particles with less agglomeration caused by fusion and sintering of particles by heat treatment. In addition, by performing heat treatment in this temperature range, the amorphous phase formed during thermal spraying crystallizes, and it is possible to lead the entire particles to eucryptite phase crystal.

When heat treatment is performed at a temperature lower than 500° C., crystallization does not proceed and the amorphous phase formed during thermal spraying remains. Therefore, it is difficult to obtain a target particle having a large negative thermal expansion coefficient.

In addition, when heat treatment is performed at a temperature higher than 1000° C., agglomerates in which particles are strongly bonded by fusion or sintering of particles are formed. In order to obtain particles having an intended particle diameter, treatment such as pulverization is required. However, it leads fractured particles, which is undesirable.

Even when agglomeration of particles occurs by heat treatment, if the bonding between particles is not strong, processing by a disintegration method with little damage to particles such as jet mill, can be carried out, thereby obtaining target spherical particles with a high circularity.

In order to obtain spherical particles by a disintegration method with agglomeration-free or less damaged particles after heat treatment, it is desirable to appropriately adjust the temperature and time of the heat treatment depending on the amorphous content after thermal spraying and the like.

In addition, for the heat treatment processing time, it is desirable to select an appropriate heat processing time (retaining time) according to the combination with the heat treatment temperature. The processing time is preferably 1 to 48 hours.

Since the heat treated particles have a negative thermal expansion coefficient, the cooling condition after the heat treatment is not particularly limited, and cracks do not occur, for example, even though quenching is performed. Therefore, the cooling conditions may be set according to conditions of use of the cooling device, etc. For example, the cooling rate may be 10 to 600° C./hour.

The spherical eucryptite particles of the present invention thus obtained have a high fluidity and dispersibility and can be highly filled in a resin, and thus the thermal expansion coefficient of a resin composition such as a semiconductor sealing material is very effectively lowered. Accordingly, it is possible to lower a possibility of cracks or warpage of the resin composition.

The spherical eucryptite particles of the present invention can be mixed as a filler with a resin and used in a resin composition. In the case of using the resin composition as a sealing material, o′-cresol novolac resin, biphenyl resin or the like can be used as the resin, although a kind of the resin is not particularly limited thereto.

When the spherical eucryptite particles of the present invention are used by being mixed with a resin, they can be mixed with the resin together with particles of SiO₂, Al₂O₃ and the like, and depending on the use of the resin composition, it is possible to adjust a thermal expansion coefficient by adjusting the formulation of the particles.

### EXAMPLES

Hereinafter, the present invention will be described in more details with reference to Examples and Comparative Examples. However, the present invention is not construed as being limited to the following examples.

Particles obtained by thermally spraying feedstock powders having various compositions and different particle diameters were heated to 700° C. at a rate of temperature increase of 100° C./hour in the atmosphere and held for 6 h and then cooled to a room temperature at a temperature lowering rate of 100° C./hour.

The average particle diameter, composition, circularity and thermal expansion coefficient of the obtained particles are shown in Table 1.

Here, the average particle diameter of the obtained particles was measured by particle size distribution measurement by a laser diffraction method, the composition was analyzed by an atomic absorption method, and the crystalline phase was measured by X-ray diffraction. The circularity was measured using a flow type particle image analyzer. Further, the obtained particles were mixed with an epoxy resin to prepare a resin mixture, and the thermal expansion coefficient of the resin composition at RT to 300° C. was measured. Assuming that the thermal expansion coefficient of the epoxy resin is 119×10⁻⁶/K, the thermal expansion coefficient of the particles was calculated.

It was confirmed by X-ray diffraction that each of Sample Nos. 1 to 6 according to the present invention contained 90% or more of eucryptite crystalline phase. In Sample Nos. 1 to 6, spherical particles having a circularity as high as 0.91 to 0.97 were obtained, and their thermal expansion coefficients were negative values of −2.6 to −7.6×10⁻⁶/K. In Sample No. 7, since the particles had a small diameter, they formed a strong agglomerate by the heat treatment and could not be used as particles. In the case of Sample Nos. 8 to 10 which are outside the composition range of the present invention, only those with a thermal expansion coefficient having positive values of 0.4 to 2.1×10⁻⁶/K were obtained. Also, the particles obtained by thermally spraying a feedstock which is the same as

Sample No. 2 were heated in the atmosphere to 450 to 1100° C. at a rate of temperature increase of 100° C./hour and maintained for a predetermined time and then cooled to a room temperature at a cooling rate of 100° C./hour. The composition, circularity and thermal expansion coefficient of the obtained particles are shown in Table 2. Sample Nos. 11 to 16, which were heat treated at 500 to 1000° C., had a high circularity of 0.91 to 0.97 and a thermal expansion coefficient of negative values of −2.1 to −9.1×10⁻⁶/K. In Sample No. 17, which was heat treated at 450° C., an amorphous pattern was observed by X-ray diffraction, and its thermal expansion coefficient was a positive value of 2.1×10⁻⁶/K. In addition, in Sample No. 18, which was heat treated at 1100° C., agglomeration of particles occurred, and spherical particles could not be obtained.

TABLE 1

| | | Ex. | Ex. | Ex. | Ex. | Ex. |
|---|---|---|---|---|---|---|
| | | No. | | | | |
| | | 1 | 2 | 3 | 4 | 5 |
| Ave. Dia.(D50) | μm | 1.4 | 6.5 | 29 | 91 | 118 |
| SiO₂ | mol % | 50.6 | 50.4 | 54.7 | 53.7 | 45.8 |
| Al₂O₃ | mol % | 24.1 | 21.3 | 20.8 | 25.6 | 27.2 |
| Li₂O | mol % | 25.3 | 28.3 | 24.5 | 20.7 | 27.0 |
| Circularity | | 0.92 | 0.97 | 0.95 | 0.93 | 0.91 |
| Thermal | ×10⁻⁶/K | −7.6 | −4.9 | −2.6 | −3.1 | −2.8 |
| Expansion | | | | | | |
| Coefficient | | | | | | |

| | | | Comp. | Comp. | Comp. | Comp. |
|---|---|---|---|---|---|---|
| | | Ex. | Ex. | Ex. | Ex. | Ex. |
| | | No. | | | | |
| | | 6 | 7 | 8 | 9 | 10 |
| Ave. Dia.(D50) | μm | 24 | 0.8 | 15 | 23 | 21 |
| SiO₂ | mol % | 49.6 | 56.4 | 44.1 | 56.1 | 54.7 |
| Al₂O₃ | mol % | 29.1 | 21.2 | 31.2 | 25.9 | 19.1 |
| Li₂O | mol % | 21.3 | 22.4 | 24.7 | 18.0 | 26.2 |
| Circularity | | 0.94 | agglo. | 0.91 | 0.90 | 0.92 |
| Thermal | ×10⁻⁶/K | −3.4 | — | 1.4 | 2.1 | 0.4 |
| Expansion | | | | | | |
| Coefficient | | | | | | |

TABLE 2

| | | Ex. | Ex. | Ex. | Ex. | Ex. |
|---|---|---|---|---|---|---|
| | | No. | | | | |
| | | 11 | 12 | 13 | 14 | 15 |
| Heat Treat. | ° C. | 500 | 600 | 700 | 800 | 900 |
| Temp. | | | | | | |
| Heat Treat. | h | 48 | 24 | 6 | 6 | 4 |
| Hold. Time | | | | | | |
| SiO₂ | mol % | 50.4 | 50.4 | 50.4 | 50.4 | 50.4 |
| Al₂O₃ | mol % | 21.3 | 21.3 | 21.3 | 21.3 | 21.3 |
| Li₂O | mol % | 28.3 | 28.3 | 28.3 | 28.3 | 28.3 |
| Circularity | | 0.97 | 0.97 | 0.97 | 0.96 | 0.94 |
| Thermal | ×10⁻⁶/K | −2.1 | −3.3 | −4.9 | −6.4 | −8.3 |
| Expansion | | | | | | |
| Coefficient | | | | | | |

| | | Ex. | Comp. Ex. | Comp. Ex. |
|---|---|---|---|---|
| | | No. | | |
| | | 16 | 17 | 18 |
| Heat Treat. | ° C. | 1000 | 450 | 1100 |
| Temp. | | | | |
| Heat Treat. | h | 1 | 48 | 1 |
| Hold. Time | | | | |
| SiO₂ | mol % | 50.4 | 50.4 | 50.4 |
| Al₂O₃ | mol % | 21.3 | 21.3 | 21.3 |
| Li₂O | mol % | 28.3 | 28.3 | 28.3 |
| Circularity | | 0.91 | 0.97 | agglo. |
| Thermal | ×10⁻⁶/K | −9.1 | 2.1 | −7.8 |
| Expansion | | | | |
| Coefficient | | | | |

1. Spherical eucryptite particles comprising a eucryptite crystalline phase containing 45 to 55 mol % of SiO₂, 20 to 30 mol % of Al₂O₃ and 20 to 30 mol % of Li₂O, and having a circularity of 0.90 to 1.0.

2. The spherical eucryptite particles according to claim 1, wherein said particles have a thermal expansion coefficient is −2×10⁻⁶/K to −10×10⁻⁶/K.

3. The spherical eucryptite particles according to claim 1, wherein the average particle diameter (D50) is more than 1 μm to 100 μm.

4. A method for producing spherical eucryptite particles according to claim 1, wherein said spherical particles are obtained by thermally spraying a feedstock powder containing 45 to 55 mol % of SiO₂, 20 to 30 mol % of Al₂O₃ and 20 to 30 mol % of Li₂O, and heat treated to obtain spherical particles containing 89% or more of a eucryptite crystalline phase.

5. The method for producing spherical eucryptite particles according to claim 4, wherein the thermally sprayed spherical particles are heat treated at 500 to 1000° C. for 1 to 48 hours.

6. The spherical eucryptite particles according to claim 2, wherein the average particle diameter (D50) is more than 1 μm to 100 μm.

7. A method for producing spherical eucryptite particles according to claim 2, wherein said spherical particles are obtained by thermally spraying a feedstock powder containing 45 to 55 mol % of SiO₂, 20 to 30 mol % of Al₂O₃ and 20 to 30 mol % of Li₂O, and heat treated to obtain spherical particles containing 89% or more of a eucryptite crystalline phase.

8. A method for producing spherical eucryptite particles according to claim 3, wherein said spherical particles are obtained by thermally spraying a feedstock powder containing 45 to 55 mol % of SiO₂, 20 to 30 mol % of Al₂O₃ and 20 to 30 mol % of Li₂O, and heat treated to obtain spherical particles containing 89% or more of a eucryptite crystalline phase.
